(19) United States
(12) Patent Application Publication
(10) Pub. No.: US 2025/0077065 A1
(43) Pub. Date: Mar. 6, 2025

(54) SCROLL TRACKING OF A WEB PAGE

(71) Applicant: Capital One Services, LLC, McLean, VA (US)

(72) Inventor: Bryan TAMAYO, Allen, TX (US)

(21) Appl. No.: 18/461,045

(22) Filed: Sep. 5, 2023

(51) Int. Cl. G06F 3/0485; G06T 11/20; G06T 11/60

(52) U.S. Cl. CPC G06F 3/0485; G06T 11/206; G06T 11/60; G06T 2200/24

(57) ABSTRACT

In some implementations, a navigation tracking device may receive navigation position data associated with a scrolling display indicating an entry point associated with the scrolling display, an exit point associated with the scrolling display, and a plurality of portions of the scrolling display accessed between a first time at which the entry point was accessed and a second time at which the exit point was accessed. The navigation tracking device may receive timing data associated with the scrolling display, the timing data indicating the first time, the second time, and an elapsed time spent accessing each of the plurality of portions of the scrolling display. The navigation tracking device may generate, based on the navigation position data and the timing data, a graphical report indicating the entry point, the exit point, and the elapsed time spent accessing each of the plurality of portions of the scrolling display.

### BACKGROUND

Computing devices, such as personal computers, tablets, mobile devices, or similar computing devices, may include a screen for displaying information. In some examples, the computing devices may not be able to display all of the information at once, such as when displaying a web page on a computing device with a relatively small screen, such as a mobile phone. Accordingly, certain digital content (e.g., web pages) may be designed such that a user may navigate through different portions of the content, such as by scrolling up and down on a web page displayed on a mobile device. Designers of digital content may be interested to know what areas of the digital content are of relatively more or less interest to users and/or what portions of the digital content are accessed more frequently than other portions. For example, web page designers may be interested in tracking what areas of a web page are most frequently viewed by visitors.

### SUMMARY

Some implementations described herein relate to a system for tracking scrolling of a web page. The system may include one or more memories and one or more processors communicatively coupled to the one or more memories. The one or more processors may be configured to receive scroll position data associated with the web page, the scroll position data indicating an entry point associated with the web page, an exit point associated with the web page, and a plurality of portions of the web page accessed between a first time at which the entry point was accessed and a second time at which the exit point was accessed. The one or more processors may be configured to receive timing data associated with the web page, the timing data indicating the first time, the second time, and an elapsed time spent accessing each of the plurality of portions of the web page. The one or more processors may be configured to generate, based on the scroll position data and the timing data, a graphical report indicating the entry point, the exit point, and the elapsed time spent accessing each of the plurality of portions of the web page. The one or more processors may be configured to reconfigure the web page based on the scroll position data and the timing data, wherein reconfiguring the web page includes moving or removing at least one content item associated with a first portion of the web page, of the plurality of portions of the web page.

Some implementations described herein relate to a method. The method may include receiving, by a navigation tracking device, navigation position data associated with a scrolling display, the navigation position data indicating an entry point associated with the scrolling display, an exit point associated with the scrolling display, and a plurality of portions of the scrolling display accessed between a first time at which the entry point was accessed and a second time at which the exit point was accessed. The method may include receiving, by the navigation tracking device, timing data associated with the scrolling display, the timing data indicating the first time, the second time, and an elapsed time spent accessing each of the plurality of portions of the scrolling display. The method may include generating, by the navigation tracking device and based on the navigation position data and the timing data, a graphical report indicating the entry point, the exit point, and the elapsed time spent accessing each of the plurality of portions of the scrolling display.

Some implementations described herein relate to a non-transitory computer-readable medium that stores a set of instructions. The set of instructions, when executed by one or more processors of a web page scroll tracking device, may cause the web page scroll tracking device to receive scroll position data associated with a web page, the scroll position data indicating an entry point associated with the web page, an exit point associated with the web page, and a plurality of portions of the web page accessed between a first time at which the entry point was accessed and a second time at which the exit point was accessed. The set of instructions, when executed by one or more processors of the web page scroll tracking device, may cause the web page scroll tracking device to receive timing data associated with the web page, the timing data indicating the first time, the second time, and an elapsed time spent accessing each of the plurality of portions of the web page. The set of instructions, when executed by one or more processors of the web page scroll tracking device, may cause the web page scroll tracking device to generate, based on the scroll position data and the timing data, a graphical report indicating the entry point, the exit point, and the elapsed time spent accessing each of the plurality of portions of the web page.

### BRIEF DESCRIPTION OF THE DRAWINGS

FIGS. 1A-1F are diagrams of an example associated with scroll tracking of a web page, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with scroll tracking of a web page, in accordance with some embodiments of the present disclosure.

FIG. 4 is a flowchart of an example process associated with scroll tracking of a web page, in accordance with some embodiments of the present disclosure.

### DETAILED DESCRIPTION

The following detailed description of example implementations refers to the accompanying drawings. The same reference numbers in different drawings may identify the same or similar elements.

Some implementations described herein enable tracking scrolling of digital content, such as by bi-directionally tracking a user's interaction with a web page and/or content contained therein. As a result, digital content (e.g., a web page) may be reconfigured to move and/or remove certain content items, thereby conserving power, computing, and network resources that are otherwise required for loading portions of the digital content that are uninteresting or inapplicable to users accessing the digital content.

In some examples, designers of digital content (e.g., web page designers) may track a user's interactions with the digital content, such as by tracking which features within the digital content are most frequently interacted with by users of the digital content (e.g., web page visitors). For example, web page designers may track multiple users' interactions with a web page over time, and may generate heat maps or similar data displays indicative of which portions of the web page are of most and/or least interest to users. The web page designers may utilize the information to redesign their web pages, such as by moving or altering certain portions of the web page in an effort to make the portions more attractive to a user and/or to increase users' interactions with the portions of the web page.

Known tracking systems provide limited information to web page designers and other designers of digital content. For example, while heat maps may show which portions of the digital content is most frequently interacted with and/or which portions of the digital content is least frequency interacted with, the tracking systems are unable to provide context as to why certain portions of the content are more or less frequently accessed. Accordingly, web page designers and similar digital content creators may reformulate digital content using incomplete information, leading to inefficient usage of power, computing, and network resources.

Some techniques and systems described herein enable increased information to be provided to digital content designers (e.g., web page designers), enabling intelligent reconfiguration of the digital content and thus more efficient usage of power, computing, and network resources. In some implementations, a scroll tracking system may be configured to track scroll position data and time data as a user interacts with digital content, such as a web page or similar content. The scroll position data may bi-directionally track a user's scroll position within the digital content, while the time data may track a relative time spent at each scroll position. In this way, the scroll tracking system may capture important analytics, such as, in addition to content that is most engaged by the user and/or least engaged by the user, a roadmap of how the user arrived at each content. This data may be indicative of whether a user passed over certain content to arrive at other content, whether a user never scrolled to some content, or similar information, providing valuable insights to a designer of the digital content. In some implementations, the scroll tracking system may generate a graphical report of the user's interaction with the digital content, such as by generation a two-dimensional or three-dimensional chart indicating an entry point to the digital content, an exit point to the digital content, elapsed time spent accessing each of multiple portions of the digital content, or the like. Additionally, or alternatively, the scroll tracking system may be capable of intelligently reconfiguring the digital content, such as by moving and/or removing certain portions thereof based on the scroll tracking data and/or timing data. In this regard, the scroll tracking system may be capable of reducing or eliminating power, computing, and network resource consumption associated with loading uninteresting and/or irrelevant portions of the digital content, thus resulting in more efficient usage of power, computing, and network resources.

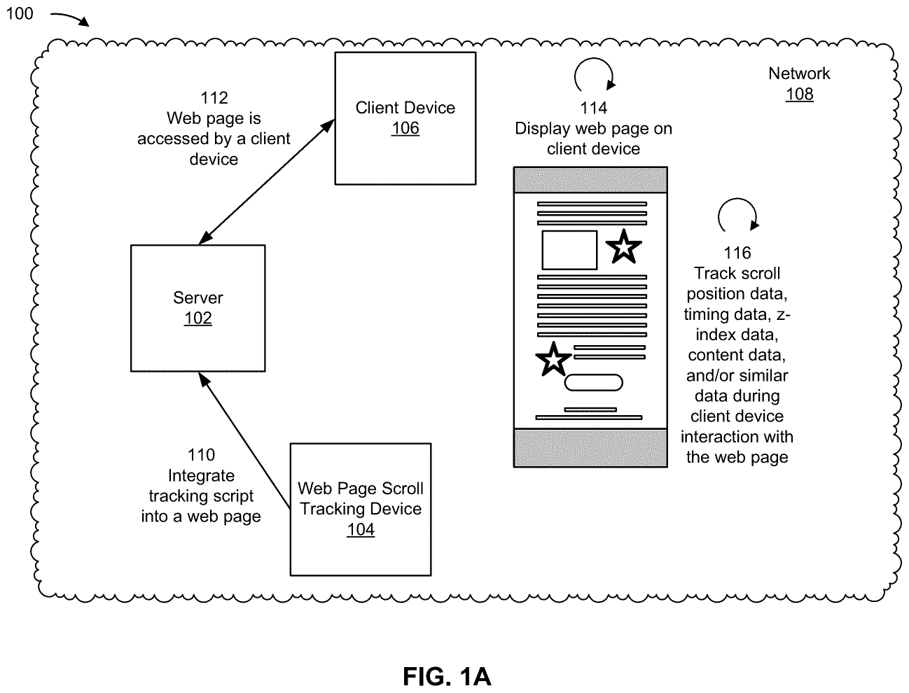

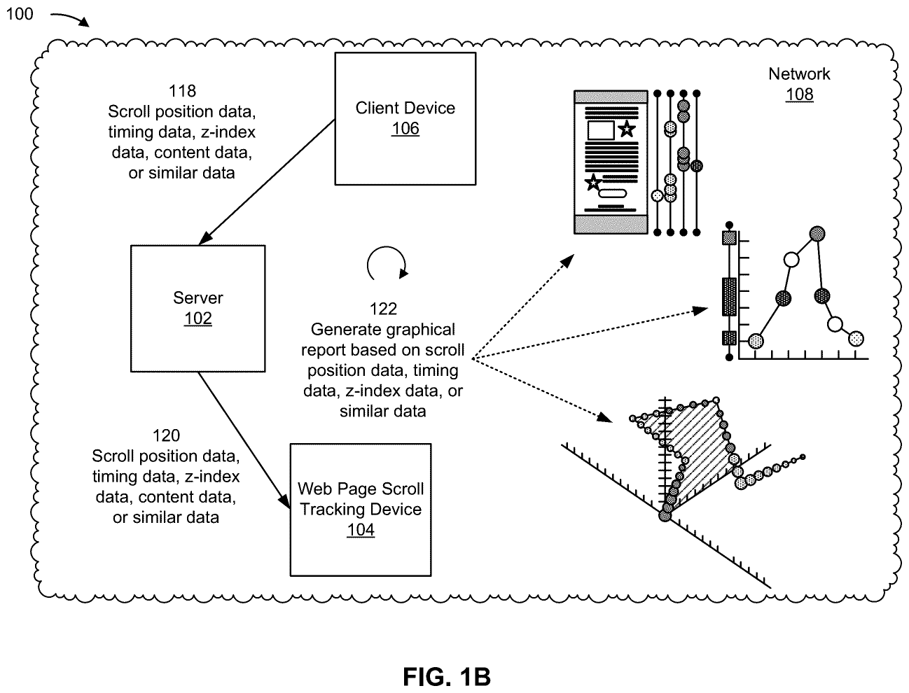

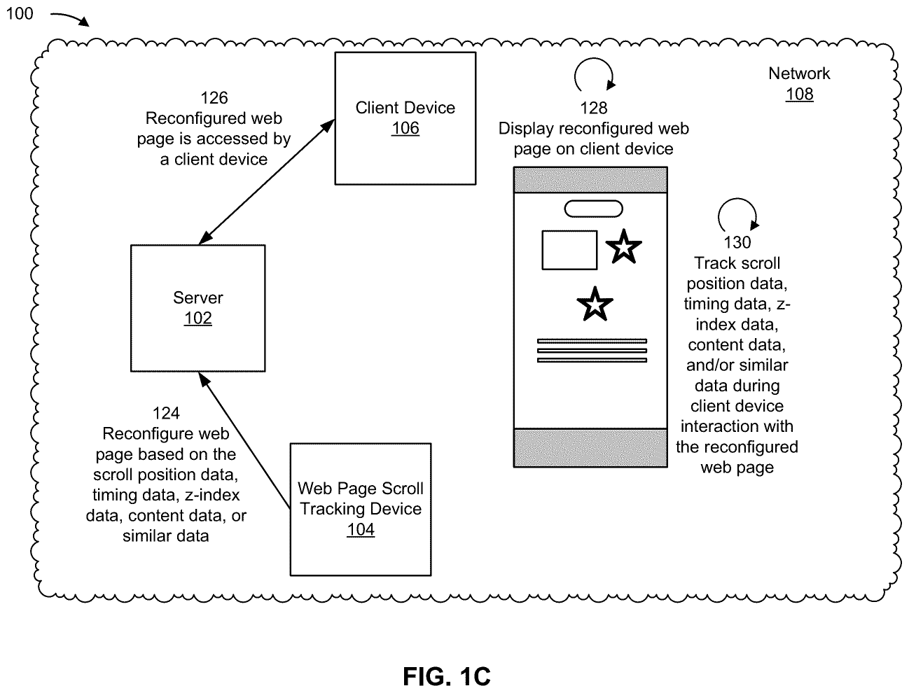

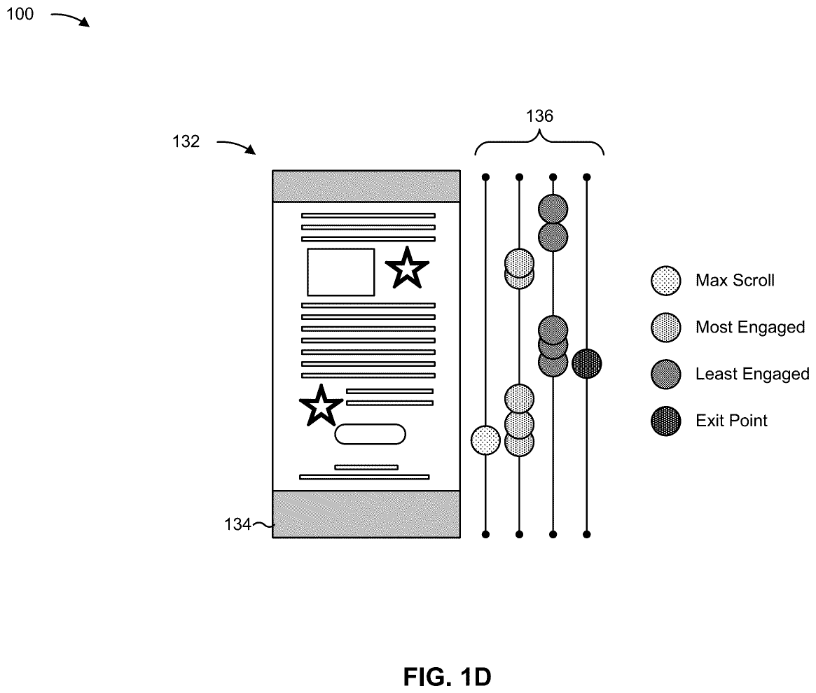

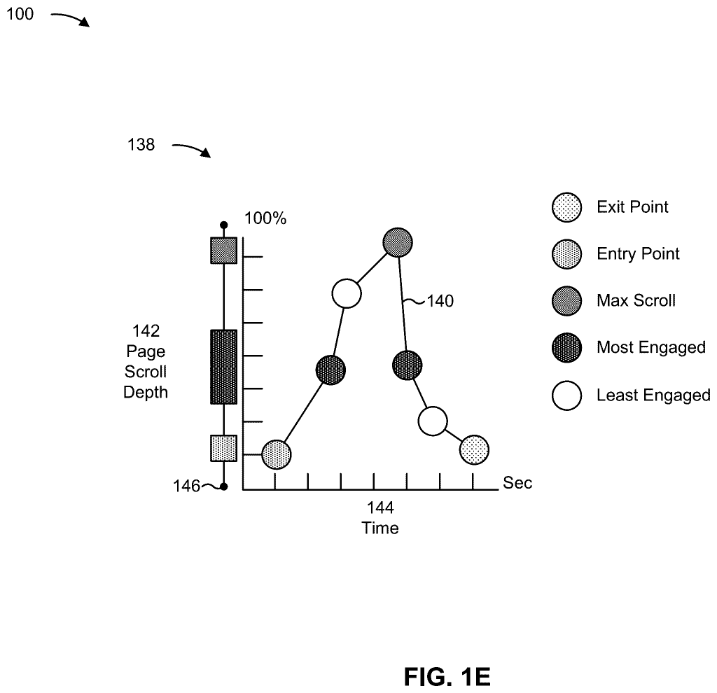

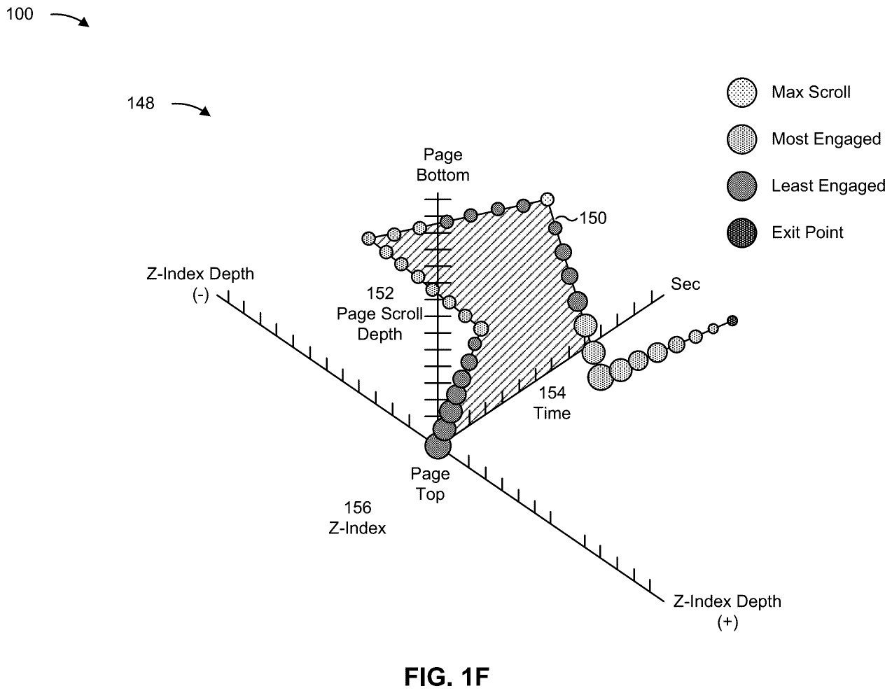

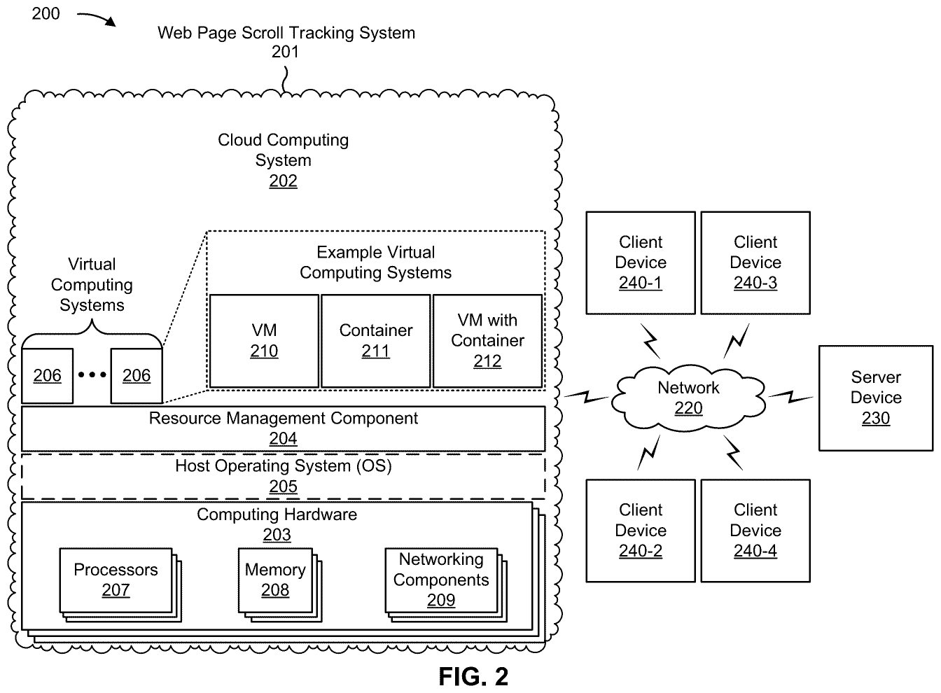

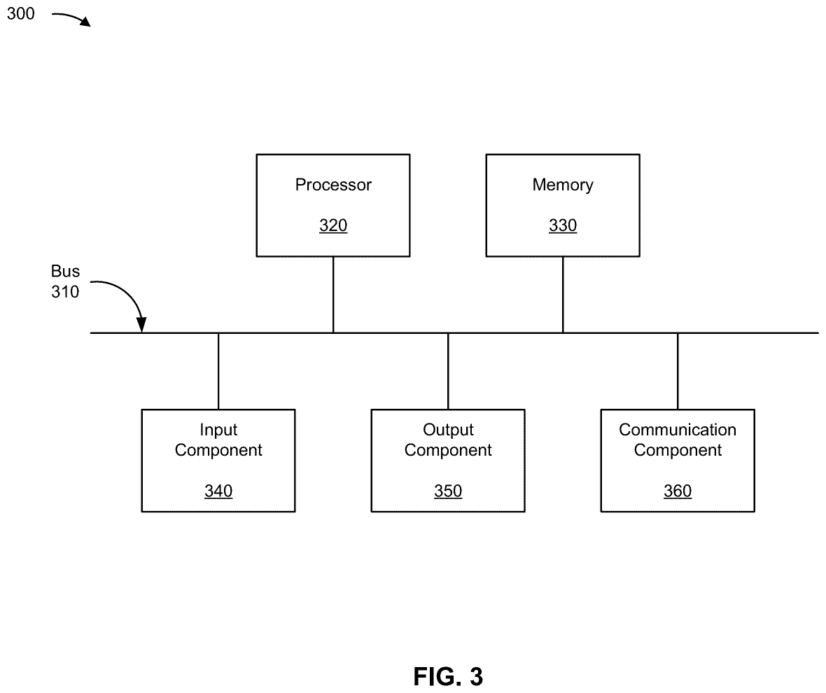

FIGS. 1A-1F are diagrams of an example 100 associated with scroll tracking of a web page. As shown in FIGS. 1A-1F, example 100 includes a server 102, a web page scroll tracking device 104 (e.g., as one example of a navigation tracking device), and a client device 106. The server 102, the web page scroll tracking device 104, and/or the client device 106 may be in communication with each other and/or may have established a connection with each other prior to the operations described below in connection with reference numbers 110-156. For example, the server 102, the web page scroll tracking device 104, and/or the client device 106 may be in communication with each other via a network 108 (e.g., a wired and/or wireless network, such as the Internet or a similar network). These devices are described in more detail in connection with FIGS. 2 and 3.

As shown in FIG. 1A, and as indicated by reference number 110, the web page scroll tracking device 104 may integrate a tracking script into a web page (e.g., into the source code for a web page). For example, the web page scroll tracking device 104 may integrate the tracking script into a web page hosted by the server 102. In some implementations, the tracking script may be a script (e.g., a sequence of instructions that may be executed without being compiled and/or that is written in a scripting language, such as Perl, PHP, Python, JavaScript, VBScript, AppleScript, PowerShell, or a similar scripting language) that is capable of tracking a navigational position and/or a scroll position of a user interacting with a display of information, such as a web page (sometimes referred to herein as scroll position data), a time spent by the user interacting with the display of information and/or the web page (sometimes referred to herein as timing data), a z-index of content on the display of information and/or the web page being accessed by the user (sometimes referred to herein as z-index data), and/or similar data. Aspects of the functionality of tracking script are described in more detail below in connection with reference numbers 116 and 130.

As indicated by reference number 112, the client device 106 may access the web page hosted by the server 102 (e.g., the client device 106 may access the web page that includes the tracking script integrated therein). For example, the client device 106 may send a request to the server 102 for the hypertext markup language (HTML) code associated with a certain web page. As indicated by reference number 114, the web page may be displayed on the client device 106 (e.g., via a display screen associated with the client device 106). More particularly, a browser or similar program at the client device 106 may display the web page based on the HTML code received from the server 102. In some implementations, the web page may be a web page that may not be entirely displayed on the client device 106 at one time. For example, the web page may extend beyond the viewable area on the client device 106 at any one time. Accordingly, the web browser or similar program on the client device may include functionality to permit a user to navigate throughout the entire web page. For example, the web browser may include functionality to support bi-directional scrolling of the web page, such that a user can interact with the web page by moving a viewable portion of the web page up and down in the browser in order to access the various content associated with the web page. Moreover, in implementations in which the tracking script is integrated into the web page (as described above in connection with reference number 110), the web page (and more particularly the tracking script integrated therein) may be configured to track certain data associated with the user's interaction of the web page, such as scroll position data, timing data, z-index data, and/or similar data, as indicated by reference number 116.

Scroll position data, sometimes referred to as navigation position data, may include an indication of an entry point associated with the web page, an exit point associated with the web page, and portions of the web page that a user accessed between a first time at which the entry point was accessed and a second time at which the exit point was accessed. In some implementations, the entry point associated with the web page may correspond to a top of a web page, such as implementations in which a user is directed to a top of a web page when first visiting a web page (e.g., by typing a web address into a web browser). In some other implementations, the entry point associated with the web page may correspond to a portion of the web page other than the top of the web page, such as when a user follows a hyperlink to a specific content item within a web page, or the like. The exit point associated with the web page may be a portion of the web page that a user was accessing when the user navigated away from the web page, such as when the user followed a link that took them to a different web page, when the user typed a new web address into the web browser, when a user closed a tab and/or the web browser, or the like.

The portions of the web page that the user accessed between the first time at which the entry point was accessed and the second time at which the exit point was accessed may correspond to the portions of the web page viewed and/or otherwise accessed by the user between the time the user first accessed the web page and the time the user navigated away from the web page. In some implementations, the tracking script may be configured to track the user's movements through the web page bi-directionally, thereby tracking a route navigated through the web page from start to finish. In that regard, the tracking script may be configured to determine if certain content on the web page was skipped over by the user, was never visible to the user, or the like.

Timing data may be data that indicates a relative time spent by the user at each scroll position (e.g., at each of the positions indicated in the scroll position data). In that regard, the timing data may indicate the first time (e.g., a time the user entered, or first accessed, the web page), the second time (e.g., a time the user exited, or last accessed, the web page), and an elapsed time spent accessing each of the portions of the web page accessed between the first time and the second time. In that regard, by aligning the timing data with the scroll position data, the tracked data may indicate a time spent accessing certain portions of the web page and/or certain content. For example, scroll positions for which a relatively long period of time elapsed while the scroll position was visible on the client device 106 may be indicative that the user found a certain portion of the web page to be interesting and/or relevant. On the other hand, scroll positions for which a relatively short period of time elapsed while the scroll position was visible on the client device 106 may be indicative that the user found a certain portion of the web page to be uninteresting and/or irrelevant. Portions of the web page for which a user quickly scrolled past may be indicative that the user did not have an opportunity to fully digest information presented therein. Portions of the web page that the user spent a relatively long period of time accessing but for which the user did not engage with a call to action (CTA) or similar content item may be indicative that there was some impediment for the user to engage the content in a meaningful way.

Z-index data may be data indicative of a z-plane dimension of content for which a user engaged with at each of the scroll positions during the time that the user accessed the web page. Put another way, the z-index data may indicate a z position of content accessed at each of the portions of the web page. In some implementations, a designer of a web page or other digital content may overlap certain elements at a portion of the web page, such as HTML elements associated with a carousel, a slideshow, or similar overlapping elements. In such implementations, a z-index of each element may be a property that defines the order of the overlapping HTML elements, with elements having a higher z-index being placed on top of elements with a lower z-index value. Accordingly, the tracking script may be configured to track a depth of content being accessed by a user at a certain scroll position by tracking a z-index of an element being interacted with by a user, such as by the user clicking, hovering, and/or performing any other engagement that is measured by depth. In implementations in which the tracking script is configured to track a z-index of elements being engaged with by the user, the z-index data may provide additional details as to which specific type of content was accessed at each scroll position.

In some other implementations, the tracking script may track other types of data as the user navigates the web page without departing from the scope of the disclosure. For example, in some implementations the tracking script may be configured to track content data associated with the user's interaction with the web page. The content data may be data related to a type and/or class of content accessed at each scroll position. For example, the tracking script may be configured to observe class labels associated with content associated with each portions of the web page to determine a type and/or class of content being accessed by the user. In some implementations, such as implementations in which the tracking script is configured to track z-index data as described above, the tracking script may further be configured to track the class labels associated with content being accessed at each z-index position in order to track the content observed in the z-index.

As shown in FIG. 1B, the web page scroll tracking device 104 may be configured to receive the scroll position data, the timing data, the z-index data, the content data (e.g., the class label data), and/or any other type of data that was tracked by the tracking script during the user's interaction with the web page. For example, in some implementations the client device 106 may store the tracked data locally as the user interacts with the web page and/or the client device 106 may transmit the tracked data to the server 102 in real-time (e.g., as the data is collected), periodically (e.g., the client device 106 may transmit a batch of data every certain quantity of seconds, or the like), when a user leaves the web page, and/or the like. In that regard, and as indicated by reference number 118, the client device 106 may transmit the scroll position data, the timing data, the z-index data, the content data, and/or any additionally tracked data to the server 102. Moreover, as indicated by reference number 120, the server 102 may forward the tracked data to the web page scroll tracking device 104 in real-time (e.g., as the data is received from the client device 106), periodically (e.g., the server 102 may transmit a batch of data every certain quantity of seconds, or the like), one time for each user session (e.g., upon receiving a user session data from the client device 106, the server 102 may forward the entirety of the user session data to the web page scroll tracking device 104), and/or the like.

As indicated by reference number 122, the web page scroll tracking device 104 may process the data received from the tracking script (e.g., via the client device 106 and/or the server 102) in order to provide an indication of a user's interaction with the web page. For example, in some implementations, the web page scroll tracking device 104 may generate, based on the scrolling position data, the timing data, the z-index data, the content data, and/or any additionally tracked data, a graphical report indicating certain features of the data, such as one of the graphical reports shown in FIG. 1B. For example, the graphical report may indicate the entry point associated with the web page, the exit point associated with the web page, an elapsed time spent accessing each of multiple portions of the web page, and/or similar features. The graphical report may be displayed at the web page scroll tracking device 104 (e.g., at a display associated with the web page scroll tracking device 104) and/or at another device (e.g., a terminal operatively connected to and/or in communication with the web page scroll tracking device). Aspects of example graphical reports that may be generated by the web page scroll tracking device 104 are described in more detail below in connection with FIGS. 1D-1F.

As shown in FIG. 1C, and as indicated by reference number 124, in some implementations the web page scroll tracking device 104 may reconfigure the web page based on certain data received via the tracking script (e.g., based on the scroll position data, the timing data, the z-index data, the content data, and/or any other tracked data). For example, the web page scroll tracking device 104 may reconfigure the web page by moving or removing at least one content item associated with one or more portions of the web page. In this regard, the web page scroll tracking device 104 may reduce resource consumption associated with subsequent visits to the web page and/or may result in a more tailored web page for an end user resulting in greater user satisfaction. Put another way, the web page scroll tracking device 104 may intelligently alter an HTML code associated with a web page to remove irrelevant and/or uninteresting HTML elements, to move frequently accessed content of the web page to a top of the web page, to move rarely accessed content to a bottom of the web page, or the like. In some implementations, based on the data received from the tracking script, the web page scroll tracking device 104 may configure certain content items and/or HTML elements for lazy loading (sometimes referred to as asynchronous loading), when means that an initialization of certain content items and/or HTML elements may be deferred until a point at which it is needed (e.g., a point at which a user scrolls to an area of the web page associated with the content). In this regard, the power, computing, and network resources otherwise associated with loading irrelevant and/or uninteresting content may be conserved.

More particularly, as indicated by reference number 126, the client device 106 may access, via the server 102, the reconfigured web page, and, as indicated by reference number 128, the client device 106 may display the reconfigured web page on the client device 106 (e.g., within a web browser on the client device). As best seen by comparing the depiction of the reconfigured web page in FIG. 1C with the depiction of the web page in FIGS. 1A and 1B, the reconfigured web page may include fewer and/or differently arranged elements as compared to the originally displayed web page. In this regard, content most interesting to a user may be presented in a more preferable position and/or content not relevant to a user may be omitted, may be moved, and/or may be reconfigured for lazy loading, or the like. In some implementations, the reconfigured web page may be associated with the tracking script such that the tracking script may further track a user's interactions with the reconfigured web page, such as for a purpose of further reconfiguration and/or optimization of the web page. For example, as indicated by reference number 130, as the user scrolls through the reconfigured web site and/or otherwise interacts with the reconfigured web site, the tracking script may track scroll position data, timing data, z-index data, content data, and/or similar data, in a similar manner as described above in connection with reference number 116. In this way, the web page scroll tracking device 104 may continually reconfigure the web page and/or reconfigure the web page in an iterative manner, further optimizing the content displayed therein and thus further reducing power, computing, and network resource consumption associated with serving and/or displaying the web page.

FIGS. 1D-1F show example graphical reports that may be generated by the web page scroll tracking device 104 according to some implementations. As shown in FIG. 1D, and as indicated by reference number 132, in some implementations a graphical report may include a screen capture of the web page 134 juxtaposed to one or more linear charts 136. The one or more linear charts may graphically indicate certain features of the user's interaction with the web page, such as the entry point, the exit point, a maximum scroll position, a most engaged scroll position, a least engaged scroll position, or the like. For example, in the example shown in FIG. 1D, a first linear chart, of the one or more linear charts 136, indicates a maximum scroll position, which is near the bottom of the screen capture of the web page 134. This may be indicative that a user scrolled nearly to the bottom of the web page but not all the way to the bottom, and thus, any content located below the maximum scroll position was never accessed by the user.

A second linear chart, of the one or more linear charts 136, indicates most engaged scroll positions. These may be scroll positions which remained visible on a user's display for more than a first time threshold. In the example shown in FIG. 1D, the most engaged scroll positions generally align with certain content features, including two star-shaped content items, a rectangular content item, and a stadium-shaped content item. This may be indicative that these features were particularly relevant and/or interesting to a user scrolling the web page. On the other hand, a third linear chart, of the one or more linear charts 136, indicates least engaged scroll positions. These may be scroll positions which remained visible on a user's display for less than a second time threshold. In the example shown in FIG. 1D, the least engaged scroll positions generally align with textual features of the web page. This may be indicative that the textual features were not relevant and/or interesting to a user scrolling the web page and/or that a user accessed, but quickly moved past, such content. A fourth linear chart, of the one or more linear charts, indicates an exit point from the web page, indicating where a user ceased accessing the web page (e.g., a point at which the user navigated away from the web page, closed a web browser, closed a tab displaying the web page in the web browser, or the like).

As shown in FIG. 1E, and as indicated by reference number 138, in some implementations a graphical report may include one or more line graphs instead of, or in addition to, the one or more linear charts. For example, the example shown in FIG. 1E includes a two-dimensional (2D) line graph 140, indicating a user's navigation of the web page as a function of time. In that regard, the graphical report may include a page scroll depth axis 142 (sometimes referred to as a scroll position axis and/or a navigation position axis), which, in this example, includes a 0% page depth (e.g., a top of the web page) at the bottom of the page scroll depth axis 142 and a 100% page depth (e.g., a bottom of the web page) at the top of the page scroll depth axis 142. The graphical report may further include a time axis 144. In this way, the user's bi-directional scrolling of the web page may be shown as a function of time, indicative of how the user navigated the web page during a browsing session.

Moreover, in some implementations, the 2D line graph 140 may include certain markers indicating information such as an entry point, an exit point, a maximum scroll position, a most engaged scroll position, or a least engaged scroll position, in a similar manner to the one or more linear charts described above in connection with FIG. 1D. For example, in the implementation shown in FIG. 1E, the line graph may include markers indicating an entry point, an exit point, a maximum scroll position, most engaged scroll positions, and least engaged scroll positions. In this way, the 2D line graph 140 may visually indicate how a user bi-directionally moved through a web page, including which portions of the web page the user stopped at to interact with, which portions of the web page the user returned to, and/or which portions of the web page the user did not interact with and/or quickly scrolled past. Moreover, in some implementations, the graphical report may include one or more linear charts that visually summarizes the user's interaction with the web page, such as the linear chart 146 shown in FIG. 1E. In this implementation, the linear chart may include markers indicating an entry point, a maximum scroll position, and most engaged scroll positions, among other markers, and/or may omit markers at the least engaged scroll positions, in order to visualizing summarize how a user interacted with the web page during a browsing session.

As shown in FIG. 1F, and as indicated by reference number 148, in some implementations a graphical report may include a three-dimensional (3D) line graph 150, indicating a user's navigation of the web page as a function of time and depth of interaction with the web page. In that regard, the graphical report may include a page scroll depth axis 152, which may be similar to the page scroll depth axis 142 described above in connection with FIG. 1E and/or which includes a 0% page depth (e.g., a top of the web page) at the bottom of the page scroll depth axis 152 and a 100% page depth (e.g., a bottom of the web page) at the top of the page scroll depth axis 152. The graphical report may further include a time axis 154, which may be similar to the time axis 144 described above in connection with FIG. 1E. Moreover, in this implementation, the graphical report may include a z-index axis 156. The z-index axis 156 may indicate a z-index of content being accessed by the user. In this way, the user's bi-directional scrolling of the web page may be shown as a function of time as well as z-index depth, indicative of how the user navigated the web page, both by scrolling and by accessing content in the z-index direction, during a browsing session.

Moreover, in a similar manner to the implementations described above in connection with FIG. 1D and FIG. 1E, in some implementations, the 3D line graph 150 may include certain markers indicating information such as an entry point, an exit point, a maximum scroll position, a most engaged scroll position, or a least engaged scroll position. For example, in the implementation shown in FIG. 1F, the 3D line graph 150 may include markers indicating an exit point, a maximum scroll position, most engaged scroll positions, and least engaged scroll positions, among other information. In this way, the 3D line graph 150 may visually indicate how a user bi-directionally moved through a web page, including which portions of the web page the user stopped to interact with and/or returned to, and which portions of the web page the user did not interact with and/or quickly scrolled past, as well as a content type accessed at each scroll position (e.g., indicated using the z-index axis 156).

By tracking a user's navigation through a web page or a similar scrolling display in this manner, information about a user's bi-directional movements and content interaction may be used to personalize and/or reconfigure web pages and similar displays, such as by moving and/or removing content, reconfiguring certain content for asynchronous loading, adjusting a relative z-index property of overlapping elements, or the like. In that regard, web pages and scrolling displays may be more efficiently configured, resulting in reduced power, computing, and network resource consumption associated with loading uninteresting and/or irrelevant portions of the web page or scrolling display, and thus resulting in more efficient power, computing, and network resource usage.

As indicated above, FIGS. 1A-1F are provided as an example. Other examples may differ from what is described with regard to FIGS. 1A-1F.

FIG. 2 is a diagram of an example environment 200 in which systems and/or methods described herein may be implemented. As shown in FIG. 2, environment 200 may include a web page scroll tracking system 201, which may include one or more elements of and/or may execute within a cloud computing system 202. The cloud computing system 202 may include one or more elements 203-212, as described in more detail below. Additionally, or alternatively, the cloud computing system 202 may include, or may be associated with, the web page scroll tracking device 104. For example, the web page scroll tracking device 104 may be associated with one or more of the virtual computing systems 206 described in more detail below. As further shown in FIG. 2, environment 200 may include a network 220 (e.g., network 108), a server device 230 (e.g., server 102), and one or more client devices 240 (e.g., client device 106), shown in FIG. 2 as a first client device 240-1 through a fourth client device 240-4. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the web page scroll tracking system 201 may include one or more elements 203-212 of the cloud computing system 202, may execute within the cloud computing system 202, and/or may be hosted within the cloud computing system 202, in some implementations, the web page scroll tracking system 201 may not be cloud-based (e.g., may be implemented outside of a cloud computing system) or may be partially cloud-based. For example, the web page scroll tracking system 201 may include one or more devices that are not part of the cloud computing system 202, such as device 300 of FIG. 3, which may include a standalone server or another type of computing device. The web page scroll tracking system 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The server device 230 may include hardware and/or software configured to host a web page, such as the web page described above in connection with FIGS. 1A-1F. In some implementations, the server device 230 may be associated with a computer program or device that provides a service to another computer program and its user, such as one or more of the client devices 240. The server device 230 may be a physical computer located in a data center and/or that runs a server program. In some implementations, the server device 230 may be a computing device that acts as a dedicated server or the server device 230 may be used as a server as well as for other purposes. Moreover, the server device 230 may be associated with a client/server programming model, in which the server device 230 and/or a server program associated with the server device 230 awaits and fulfills requests from a client device 240 and/or a client program associated with the client device 240, which might be running in the same, or other computers. In some implementations, the server device 230 may be, or may be associated with, a web server that serves web pages to client devices 240.

The client device 240 may include a personal computer, a tablet, a mobile device, a workstation, a terminal, or a similar device that is capable of requesting access to a service provided by the server device 230. In some implementations, the client device 240 may include a web browser or a similar program configured to display a web page thereon, and/or the client device 240 may be capable of accessing a web page hosted by the server device 230, in a similar manner as described above in connection with FIGS. 1A-1F.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with scroll tracking of a web page. The device 300 may correspond to the server 102 and/or the server device 230, the client device 106 and/or the client device 240, the web page scroll tracking device 104, and/or any device described above in connection with the web page scroll tracking system 201. In some implementations, the server 102 and/or the server device 230, the client device 106 and/or the client device 240, the web page scroll tracking device 104, and/or any device described above in connection with the web page scroll tracking system 201 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

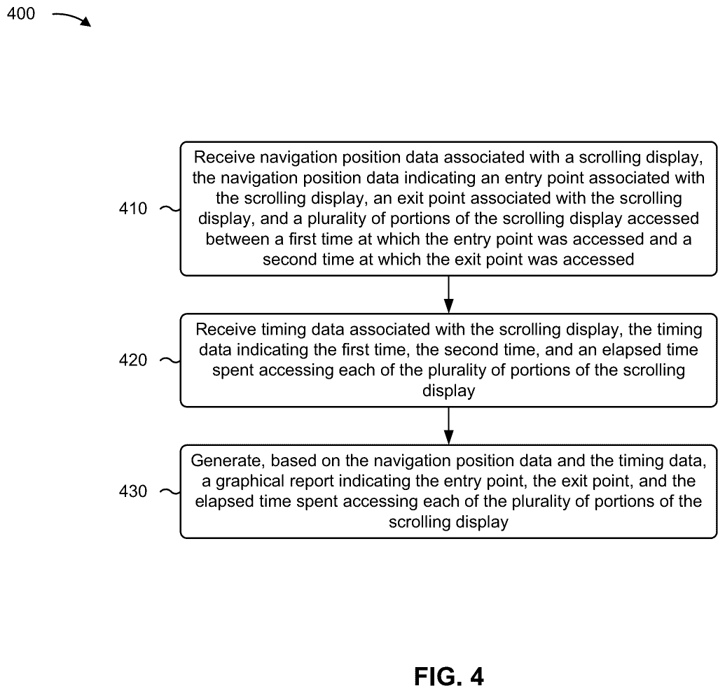

FIG. 4 is a flowchart of an example process 400 associated with scroll tracking of a web page. In some implementations, one or more process blocks of FIG. 4 may be performed by the web page scroll tracking system 201. In some implementations, one or more process blocks of FIG. 4 may be performed by another device or a group of devices separate from or including the web page scroll tracking system 201, such as the web page scroll tracking device 104, the server 102 and/or the server device 230, and/or the client device 106 and/or the client device 240. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving navigation position data associated with a scrolling display, the navigation position data indicating an entry point associated with the scrolling display, an exit point associated with the scrolling display, and a plurality of portions of the scrolling display accessed between a first time at which the entry point was accessed and a second time at which the exit point was accessed (block 410). For example, the web page scroll tracking system 201 (e.g., using processor 320, memory 330, input component 340, and/or communication component 360) may receive navigation position data associated with a scrolling display, the navigation position data indicating an entry point associated with the scrolling display, an exit point associated with the scrolling display, and a plurality of portions of the scrolling display accessed between a first time at which the entry point was accessed and a second time at which the exit point was accessed, as described above in connection with reference numbers 116-120 of FIGS. 1A-1B. As an example, using a tracking script integrated with a web page, or the like, the process 400 may include tracking a user's navigation of a web page, such as by tracking a user's bi-directional scrolling of the web page and/or a z-index associated with content accessed at each portion of the web page.

As further shown in FIG. 4, process 400 may include receiving timing data associated with the scrolling display, the timing data indicating the first time, the second time, and an elapsed time spent accessing each of the plurality of portions of the scrolling display (block 420). For example, the web page scroll tracking system 201 (e.g., using processor 320, memory 330, input component 340, and/or communication component 360) may receive timing data associated with the scrolling display, the timing data indicating the first time, the second time, and an elapsed time spent accessing each of the plurality of portions of the scrolling display, as described above in connection with reference numbers 116-120 of FIGS. 1A-1B. As an example, using a tracking script integrated with a web page, or the like, the process 400 may include tracking a user's navigation of a web page, such as by tracking an amount of time spent accessing each portion of the web page scrolled to by the user during a browsing session.

As further shown in FIG. 4, process 400 may include generating, based on the navigation position data and the timing data, a graphical report indicating the entry point, the exit point, and the elapsed time spent accessing each of the plurality of portions of the scrolling display (block 430). For example, the web page scroll tracking system 201 (e.g., using processor 320 and/or memory 330) may generate, based on the navigation position data and the timing data, a graphical report indicating the entry point, the exit point, and the elapsed time spent accessing each of the plurality of portions of the scrolling display, as described above in connection with reference number 122 of FIG. 1B. As an example, the process 400 may include generating one or more linear charts, 2D line graphs, 3D line graphs, and/or similar graphical reports indicative of a user's movement through a web page, such as one or more of the linear charts, 2D line graphs, and/or 3D line graphs described above in connection with FIGS. 1D-1F.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1F. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for tracking scrolling of a web page, the system comprising:
one or more memories; and
one or more processors, communicatively coupled to the one or more memories, configured to:
receive scroll position data associated with the web page, the scroll position data indicating an entry point associated with the web page, an exit point associated with the web page, and a plurality of portions of the web page accessed between a first time at which the entry point was accessed and a second time at which the exit point was accessed;
receive timing data associated with the web page, the timing data indicating the first time, the second time, and an elapsed time spent accessing each of the plurality of portions of the web page;
generate, based on the scroll position data and the timing data, a graphical report indicating the entry point, the exit point, and the elapsed time spent accessing each of the plurality of portions of the web page; and
reconfigure the web page based on the scroll position data and the timing data, wherein reconfiguring the web page includes moving or removing at least one content item associated with a first portion of the web page, of the plurality of portions of the web page.

2. The system of claim 1, wherein the one or more processors are further configured to receive z-index data associated with the plurality of portions of the web page, wherein the z-index data indicates a z position of content accessed at each of the plurality of portions of the web page.

3. The system of claim 2, wherein the one or more processors, to receive the scroll position data, the timing data, and the z-index data, are configured to receive to receive the scroll position data, the timing data, and the z-index data via a tracking script associated with the web page.

4. The system of claim 3, wherein the tracking script is configured to track class labels associated with content associated with the plurality of portions of the web page, and
wherein the one or more processors are further configured to receive content data associated with the web page, the content data being based on the class labels.

5. The system of claim 1, wherein the graphical report includes a screen capture of the web page juxtaposed to one or more linear charts.

6. The system of claim 1, wherein the graphical report indicates at least one of the entry point, the exit point, a maximum scroll position, a most engaged scroll position, or a least engaged scroll position.

7. The system of claim 6, wherein the at least one content item is associated with the least engaged scroll position.

8. The system of claim 1, wherein the graphical report includes a chart associated with at least two of a time axis, a scroll position axis, and a z-index axis.

9. A method, comprising:
receiving, by a navigation tracking device, navigation position data associated with a scrolling display, the navigation position data indicating an entry point associated with the scrolling display, an exit point associated with the scrolling display, and a plurality of portions of the scrolling display accessed between a first time at which the entry point was accessed and a second time at which the exit point was accessed;
receiving, by the navigation tracking device, timing data associated with the scrolling display, the timing data indicating the first time, the second time, and an elapsed time spent accessing each of the plurality of portions of the scrolling display; and
generating, by the navigation tracking device and based on the navigation position data and the timing data, a graphical report indicating the entry point, the exit point, and the elapsed time spent accessing each of the plurality of portions of the scrolling display.

10. The method of claim 9, further comprising receiving, by the navigation tracking device, z-index data associated with the plurality of portions of the scrolling display, wherein the z-index data indicates a z position of content accessed at each of the plurality of portions of the scrolling display.

11. The method of claim 10, wherein receiving the navigation position data, the timing data, and the z-index data comprises receiving the navigation position data, the timing data, and the z-index data via a tracking script associated with the scrolling display.

12. The method of claim 11, wherein the tracking script is configured to track class labels associated with content associated with the plurality of portions of the scrolling display, and
wherein the method further comprises receiving content data associated with the scrolling display, the content data being based on the class labels.

13. The method of claim 9, wherein the graphical report includes a screen capture of the scrolling display juxtaposed to one or more linear charts.

14. The method of claim 9, wherein the graphical report indicates at least one of the entry point, the exit point, a maximum scroll position, a most engaged scroll position, or a least engaged scroll position.

15. The method of claim 9, wherein the graphical report includes a chart associated with at least two of a time axis, a navigation position axis, and a z-index axis.

16. A non-transitory computer-readable medium storing a set of instructions, the set of instructions comprising:
one or more instructions that, when executed by one or more processors of a web page scroll tracking device, cause the web page scroll tracking device to:
receive scroll position data associated with a web page, the scroll position data indicating an entry point associated with the web page, an exit point associated with the web page, and a plurality of portions of the web page accessed between a first time at which the entry point was accessed and a second time at which the exit point was accessed;
receive timing data associated with the web page, the timing data indicating the first time, the second time, and an elapsed time spent accessing each of the plurality of portions of the web page; and
generate, based on the scroll position data and the timing data, a graphical report indicating the entry point, the exit point, and the elapsed time spent accessing each of the plurality of portions of the web page.

17. The non-transitory computer-readable medium of claim 16, wherein the one or more processors are further configured to receive z-index data associated with the plurality of portions of the web page, wherein the z-index data indicates a z position of content accessed at each of the plurality of portions of the web page.

18. The non-transitory computer-readable medium of claim 17, wherein the one or more instructions, that cause the web page scroll tracking device to receive the scroll position data, the timing data, and the z-index data, cause the web page scroll tracking device to receive to receive the scroll position data, the timing data, and the z-index data via a tracking script associated with the web page.

19. The non-transitory computer-readable medium of claim 18, wherein the tracking script is configured to track class labels associated with content associated with the plurality of portions of the web page, and
wherein the one or more instructions further cause the web page scroll tracking device to receive content data associated with the web page, the content data being based on the class labels.

20. The non-transitory computer-readable medium of claim 16, wherein the graphical report indicates at least one of the entry point, the exit point, a maximum scroll position, a most engaged scroll position, or a least engaged scroll position.
